(19) United States
(12) Patent Application Publication
(10) Pub. No.: US 2011/0150272 A1
(43) Pub. Date: Jun. 23, 2011

(54) SYSTEMS AND METHODS OF TRACKING OBJECT PATHS

(75) Inventors: Ganesh GunasekaranBabu, Coimbatore (IN); Gopalakrishnan Venkatesan, Aandalpuram (IN); Balaji Badhey Sivakumar, Madurai (IN); Abdul Raheem, Madurai (IN)

(73) Assignee: Honeywell International Inc., Morristown, NJ (US)

(21) Appl. No.: 12/642,944

(22) Filed: Dec. 21, 2009

(51) Int. Cl. G06K 9/00

(52) U.S. Cl. 382/103

(57) ABSTRACT

Systems and methods for tracking the path of a user configurable object are provided. The method includes displaying a video data stream of a monitored region, configuring an object in the video data stream, configuring a valid path of the object, tracking a path of the object, and providing an alert to a user when the object travels outside of the valid path.

### FIELD OF INVENTION

The present invention relates generally to video surveillance. More particularly, the present invention relates to systems and methods of tracking the path of a user configurable object.

### BACKGROUND

Intelligent security has become a widespread and necessary reality of modern day civilization, and one aspect of known intelligent security is video surveillance. Video surveillance is an integral part of the technology used in modern day security systems.

Known security systems can include surveillance cameras, video recorders, and video viewers. The surveillance cameras or other data collection devices can monitor a particular region, and video data streams from the cameras can be displayed and monitored by security personnel on video viewers or monitors. The video can be stored in associated video recorders or other data storage devices.

Traditionally, tracking an object or an object path with video surveillance has been a manual process. However, video surveillance is being increasingly used, and the amount of digital video information has become enormous. As the availability of digital video information increases, the need to track objects and object paths has also increased. Thus, the process of manually tracking objects has become an excessively time consuming and tedious process. The time, expense, and man hours associated with manually tracking an object has led many users to desire a system and method for automatically tracking an object.

Some systems and methods have been developed for tracking an object by analyzing a video data stream and notifying a user when needed. However, these systems and methods require that the layout of the monitored area be known. Furthermore, these systems and methods require significant user intervention.

When tracking an object in known systems and methods, an object, such as a car, person, or truck, must be uniquely identified. Then, the path in which the object moves can be tracked. If the object deviates from a preconfigured path, a notification is provided to a user. For example, if an object enters a restricted zone or takes a wrong turn, such as a car taking a wrong left, right, or U-turn, the user can be notified.

Known systems and methods do not appear track the particular path of the object. Instead, known systems and methods only track the direction in which the object is traveling.

Furthermore, known systems and objects do not allow a user to configure an object to be tracked. Instead, known systems and methods require that an object be identified based on a preconfigured definition of an object, such as a car, person, or truck.

There is thus a continuing, ongoing need for a system and method to track a user configurable object. Preferably, such systems and methods track the complete path of the object.

### BRIEF DESCRIPTION OF THE DRAWINGS

FIG. 1 is a flow diagram of a method of detecting an object in a video data stream in accordance with the present invention;

FIG. 2 is a flow diagram of a method of tracking an object's path in a video data stream in accordance with the present invention;

FIG. 3 is a block diagram of a system for carrying out the methods of FIG. 1 and FIG. 2;

FIG. 4 is an interactive window displayed on a viewing screen of a graphical user interface for selecting a video data stream in accordance with the present invention;

FIG. 5 is an interactive window displayed on a viewing screen of a graphical user interface for selecting a frame of a video data stream in accordance with the present invention;

FIG. 6 is an interactive window displayed on a viewing screen of a graphical user interface for designating the boundaries of a selected object in accordance with the present invention;

FIG. 7 is an interactive window displayed on a viewing screen of a graphical user interface for training the system with the selected object in accordance with the present invention;

FIG. 8 is an interactive window displayed on a viewing screen of a graphical user interface for verifying a selected object in accordance with the present invention;

FIG. 9 is an interactive window displayed on a viewing screen of a graphical user interface for viewing a threshold image of a selected object in accordance with the present invention;

FIG. 10 is an interactive window displayed on a viewing screen of a graphical user interface for selecting valid paths for a selected object in accordance with the present invention;

FIG. 11 is an interactive window displayed on a viewing screen of a graphical user interface for tracking the path of a selected object in accordance with the present invention;

FIG. 12 is an interactive window displayed on a viewing screen of a graphical user interface for notifying a user that a selected object has traveled in a restricted path in accordance with the present invention; and

FIG. 13 is an interactive window displayed on a viewing screen of a graphical user interface for displaying the path of a selected object in accordance with the present invention.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include a system and method to track a user configurable object. Preferably, such systems and methods track the complete path of the object.

In accordance with the present invention, an object can be selected, identified, and configured from a video data stream. The video data stream can be live or prerecorded. Once the selected object has been identified and configured, permitted or valid paths in which the selected object can travel can be identified. Additionally or alternatively, restricted paths in which the selected object cannot travel can be identified.

A video viewer or monitor can display a video data stream, and an object displayed in the video data stream can be configured by a user. For example, when a particular object is displayed on the monitor, a user can select or mark the object. Properties of the object, such as the perimeter and color of the object, can be automatically identified by the system. The properties of the object can be saved and used for tracking the selected object.

In accordance with systems and methods of the present invention, once the properties of the selected object are selected and/or identified, the selected objects and other similar objects can be identified throughout the video data stream. Thus the selected object and other similar objects can be tracked.

In some embodiments of the present invention, the video data stream can be associated with a grid that includes a plurality of rectangular areas. The size of the grid and the rectangular area can be selected and defined by a user, as necessary.

Using the grid, a user can configure valid or permitted path in which the selected object can travel. Additionally or alternatively, a user can utilize the grid to configure restricted paths in which the selected object cannot travel.

For example, the grid can contain six rectangular areas 1, 2, 3, 4, 5, 6. A user can configure a valid path in which the selected object can travel to be from area 1 to area 5 and then to area 6. The user can configure all other paths to be restricted.

The location of the selected object and other similar objects can be periodically determined. For example, the coordinates and rectangular areas of the grid associated with the video data stream can be used to identify an object's position. Based on present and past positions, systems and methods of the present invention can determine if a selected object is moving along a trajectory that would be consistent with a valid or permitted path.

If the selected object or any other similar objects is determined to have a trajectory that would be inconsistent with a valid or permitted path and/or would be consistent with a restricted path, an alarm can be provided to a user substantially immediately. An alarm in accordance with the present invention can notify a user when the selected object has an improper trajectory and/or travels in a restricted path.

Systems and methods in accordance with the present invention can be employed in a variety of applications. For example, systems and methods of the present invention can be employed in connection with an analytics engine for video surveillance systems, or video surveillance systems for tracking objects in a live video data stream.

For example, in an airport setting, once a piece of baggage is checked with an airline and placed in a secured area, that piece of baggage cannot be removed from the secured area. In accordance with systems and methods of the present invention, pieces of baggage and/or luggage can be configured and identified as a selected object. A restricted path can be configured to be any path from a secured area to an unsecured area. The path of any particular piece of checked baggage can be tracked so that an alarm is provided to a user if the checked baggage moves from a secured area to an unsecured area.

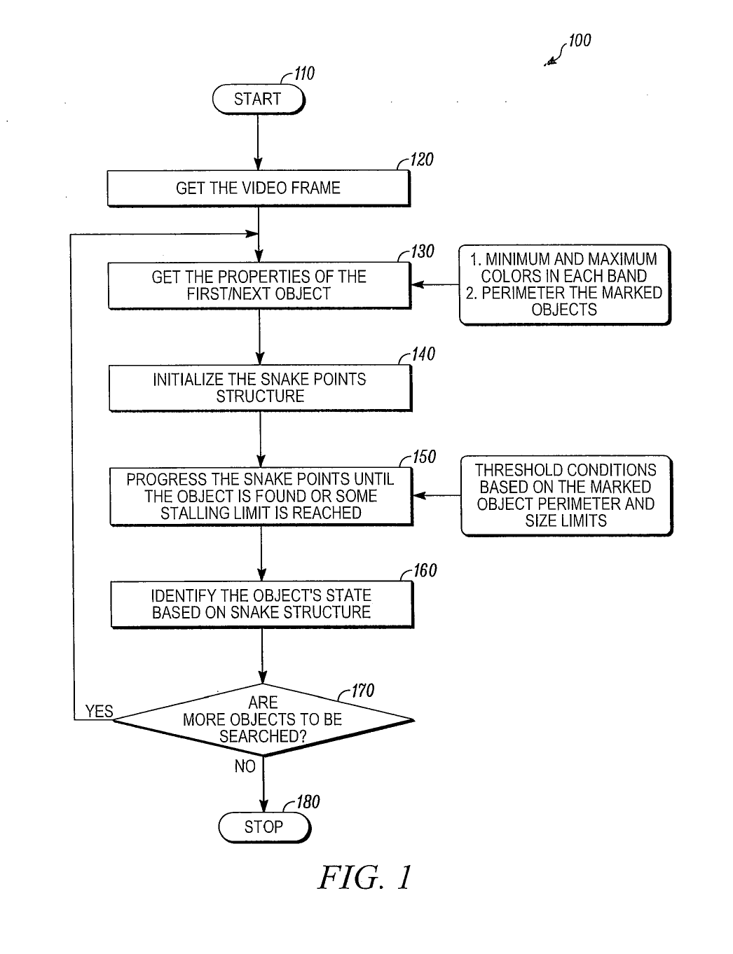

FIG. 1 is a flow diagram of an exemplary method 100 of detecting an object in a video data stream in accordance with the present invention. In the method 100, a frame from a video data stream can be retrieved as in 120. Then, the properties of a desired object can be retrieved as in 130. For example, when retrieving the properties of a desired object, the minimum and maximum color for the desired object can be identified, and the perimeter of the desired object can be identified, marked, and/or configured.

Once the properties of a desired object are retrieved, a snake point structure can be initialized as in 140. For example, the snake point structure can include the retrieved properties of a desired object and can be used for detecting an object in the frame that includes the retrieved properties. The snake point structure can progress through the frame until an object including the retrieved properties is found as in 150. If the snake point structure progresses through the entire frame without finding an object with the retrieved properties, the method 100 can begin anew.

However, if an object that includes the retrieved properties is found, that object is selected. The state of the selected object can be identified as in 160. Then, if more objects are to be detected, the method 100 can proceed to retrieve the properties of the next object as in 130.

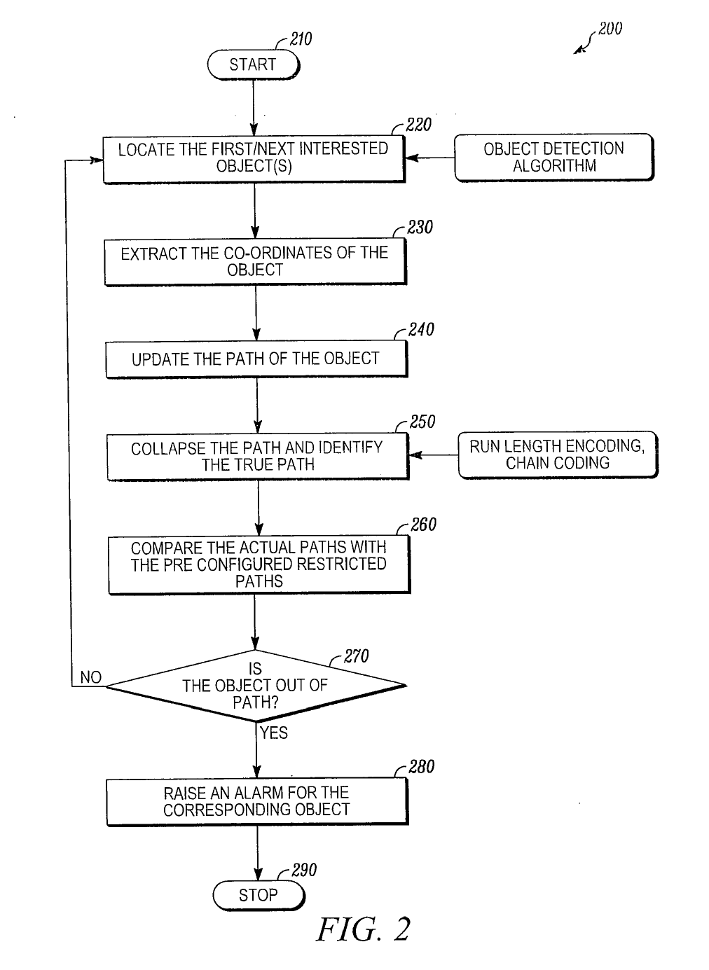

FIG. 2 is a flow diagram of a method 200 of tracking an object's path in a video data stream in accordance with the present invention. In the method 200, an object can be detected and located as in 220 according to the method 100. Once an object is detected, the coordinates of the object in a video frame can be extracted as in 230. A grid associated with the frame can be used to extract an object's coordinates.

Based on previous known coordinates and the newly extracted coordinates of an object, the path of the object can be updated as in 240. The path of the object can be collapsed to identify the true and complete path of the object as in 250. For example, the path of the object determined in 240 can be used to calculate the trajectory of the object. Based on the calculated trajectory, the actual path in which the object is traveling can be determined.

The actual path of the object can be compared with a preconfigured restricted path as in 260 to determine if the object is traveling in a valid or restricted path as in 270. If the object is not traveling in a restricted path, the method 200 can continue tracking the object. However, if the object is traveling in a restricted path, an alarm can be raised as in 280 to alert a user.

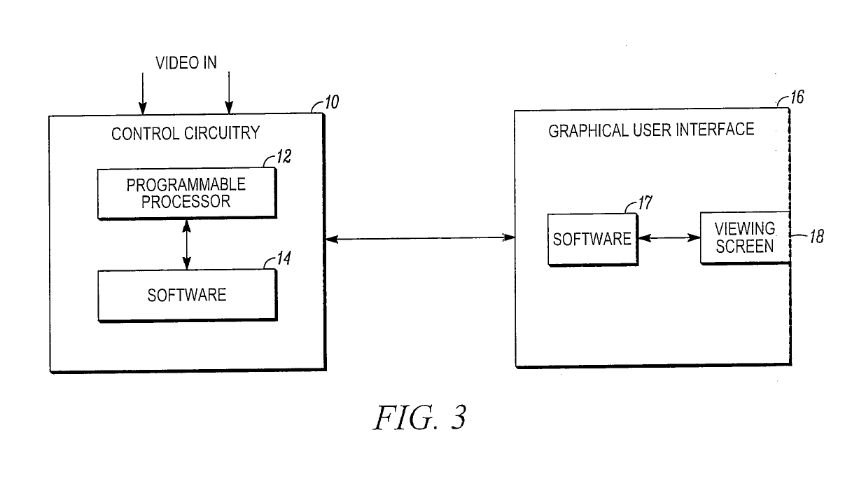

The methods shown in FIG. 1 and FIG. 2 and others in accordance with the present invention can be implemented with a programmable processor and associated control circuitry. As seen in FIG. 3, control circuitry 10 can include a programmable processor 12 and associated software 14, stored on a local computer readable medium, as would be understood by those of ordinary skill in the art. Real-time or pre-stored video data streams can be input into the programmable processor 12 and associated control circuitry.

Software 14, which can implement the exemplary methods of FIG. 1 and FIG. 2, can be stored on a computer readable medium, for example, a disk or solid state memory, and be executed by a processor 12. The disk and associated software 14 can be removably coupled to the programmable processor 12. Alternatively, the software 14 can be downloaded to the medium via a computer network.

An associated graphical user interface 16 can be in communication with the processor 12 and associated circuitry 10. A viewing screen 18 of the user interface, as would be known by those of skill in the art, can display interactive and viewing windows. In embodiments of the present invention, the user interface 16 can be a multi-dimensional graphical user interface.

The interactive and viewing windows shown and described herein are exemplary only. Those of skill in the art will understand that the features of the windows shown and described herein may be displayed by additional or alternate windows.

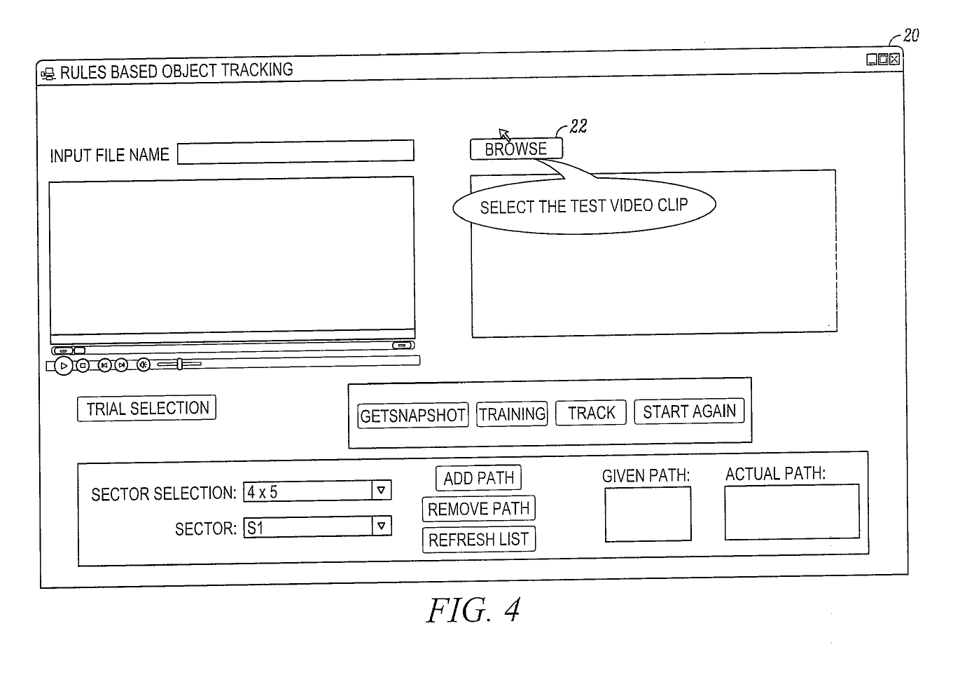

FIG. 4 is an interactive window 20 displayed on a viewing screen of a graphical user interface for selecting a video data stream in accordance with the present invention. For example, as seen in FIG. 4, a user can select a desired video data stream by selecting a BROWSE button 22 to browse for the associated file name.

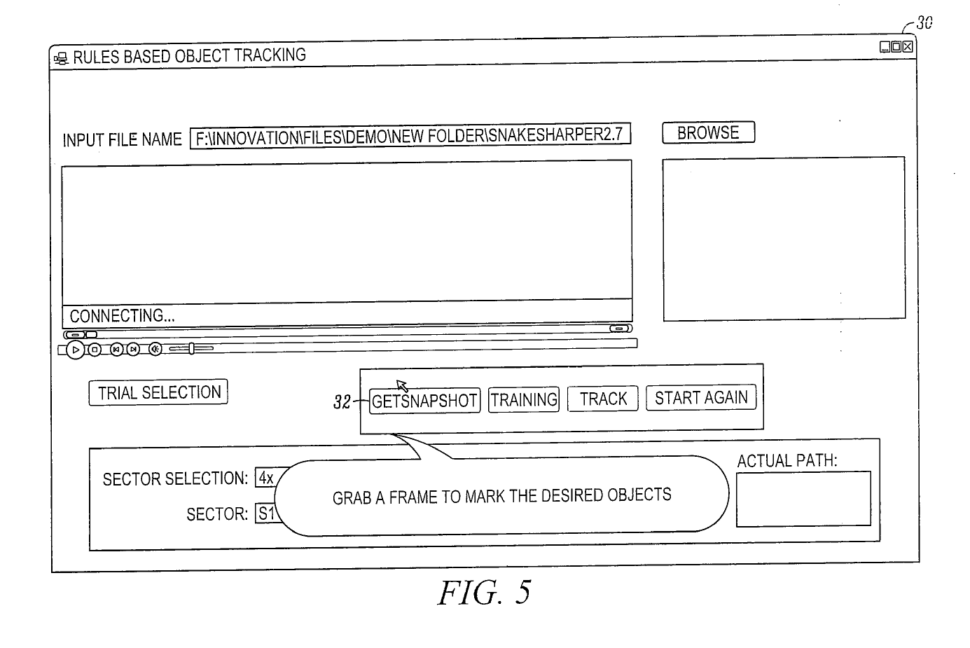

FIG. 5 is an interactive window 30 displayed on a viewing screen of a graphical user interface for selecting a frame of a video data stream in accordance with the present invention. After a user selects a desired video data stream, that video data stream can be displayed in the window 30. When a desired frame of the video data stream is being displayed, a user can retrieve the desired frame by, for example, selecting a GET SNAPSHOT button 32.

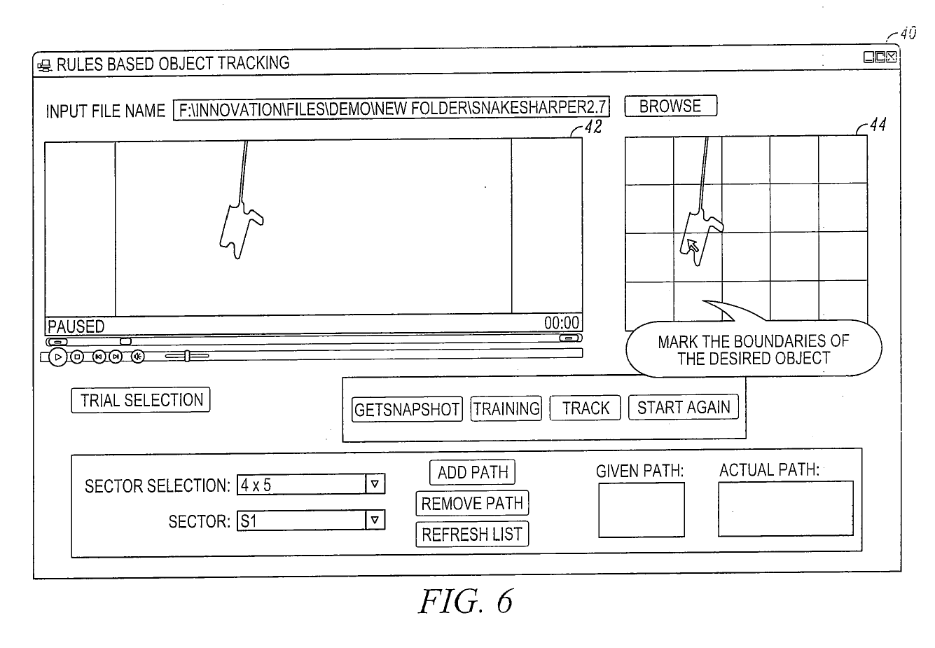

FIG. 6 is an interactive window 40 displayed on a viewing screen of a graphical user interface for designating the boundaries of a selected object in accordance with the present invention. As seen in FIG. 6, a first sub-window 42 can display the selected video data stream, and a second sub-window 44 can display the selected frame.

A grid can be associated with the selected video data stream and/or with the selected frame. In embodiments of the present invention, the grid can include a plurality of rectangular areas. The size of the grid and the rectangular areas can be determined by a user.

A user can identify a particular object in the selected frame and systems in accordance with the present invention can identify properties associated with that object. For example, systems in accordance with the present invention can identify the color and/or perimeter of the object.

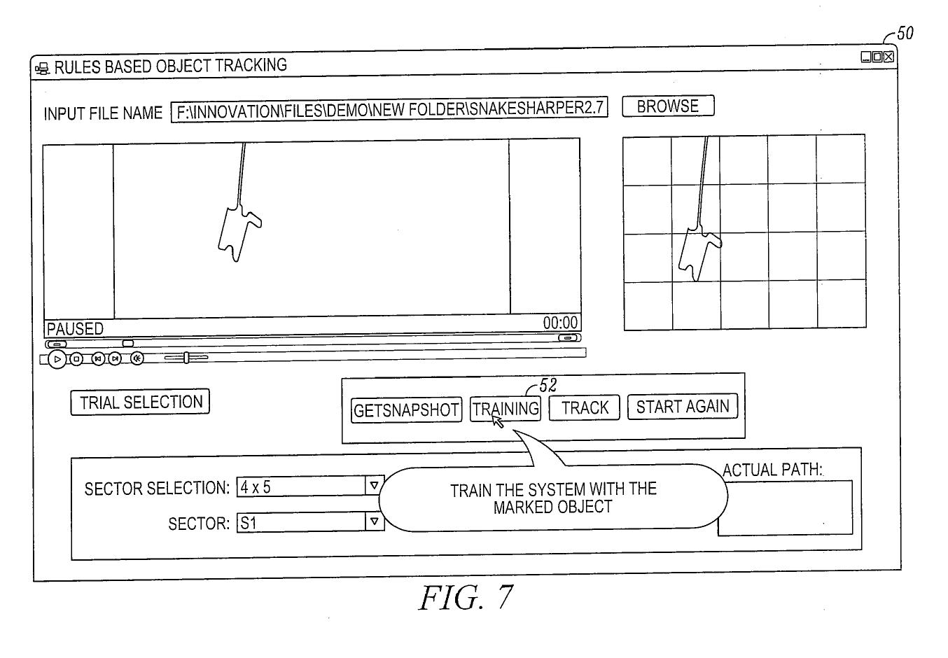

FIG. 7 is an interactive window 50 displayed on a viewing screen of a graphical user interface for training the system with the selected object in accordance with the present invention. After a user has identified a particular object and the system has automatically identified various properties associated with the object, the properties of the object can be saved and used to identify and track the selected object and other similar objects. For example, a user can select a TRAINING button 52 to ensure that the system identifies and tracks the selected object and other objects with similar and/or identical identified properties.

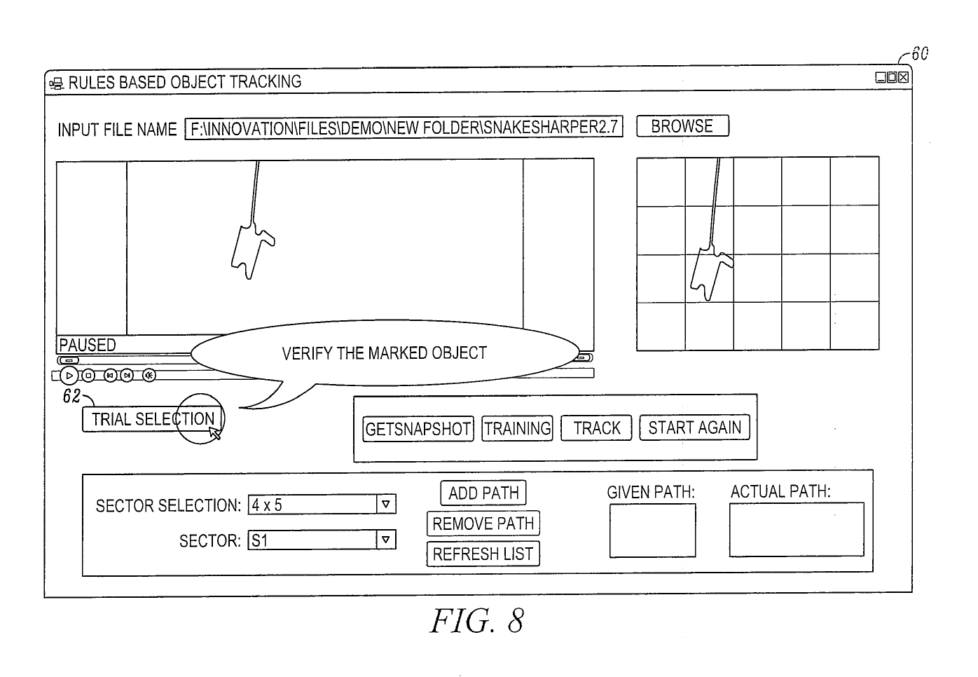

FIG. 8 is an interactive window 60 displayed on a viewing screen of a graphical user interface for verifying a selected object in accordance with the present invention. For example, to verify that an object has been defined with the selected properties, a user can select a TRIAL SELECTION button 62.

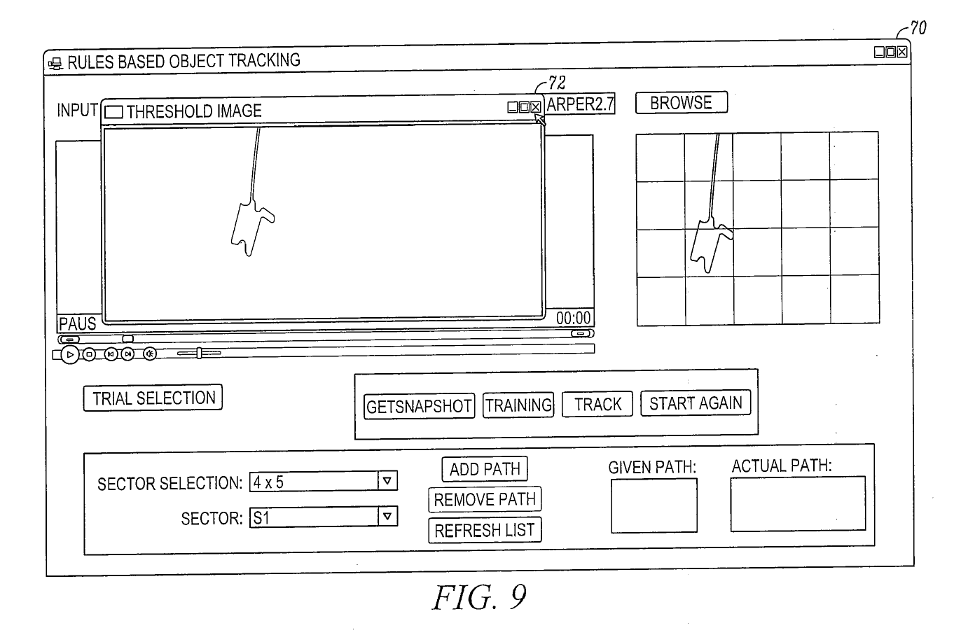

FIG. 9 is an interactive window 70 displayed on a viewing screen of a graphical user interface for viewing a threshold image of a selected object in accordance with the present invention. A pop up window 72, for example, can appear showing a threshold image of an object with the selected properties. In embodiments of the present invention, the threshold image defines the properties that an object must include to be selected and tracked.

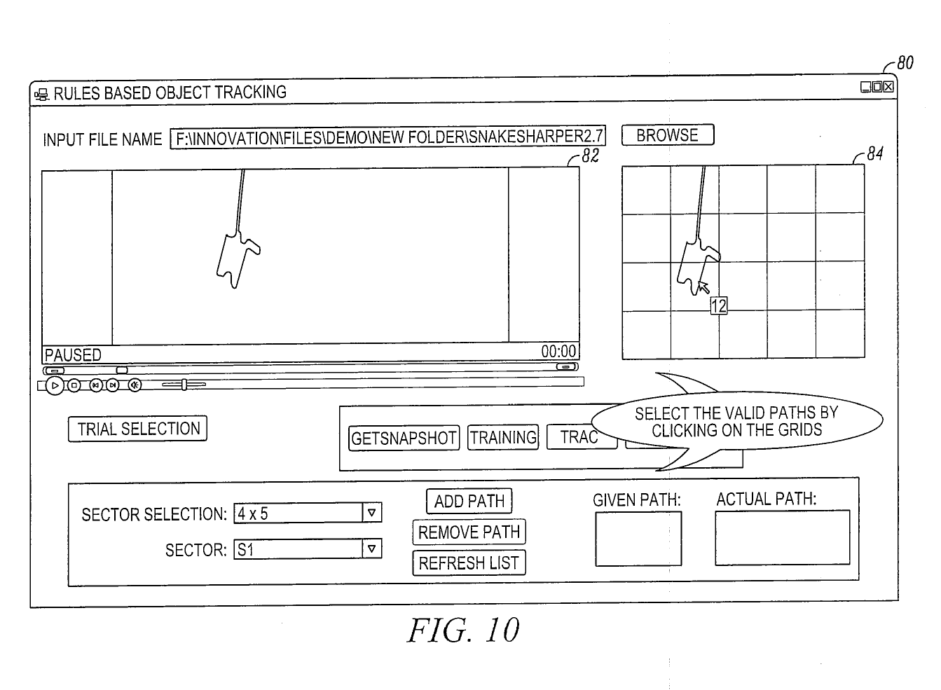

FIG. 10 is an interactive window 80 displayed on a viewing screen of a graphical user interface for selecting valid paths for a selected object in accordance with the present invention. Using the grid and rectangular areas associated with the selected video frame, a user can identify valid and restricted paths for the selected object. For example, the user can select a series of rectangular areas to define a path and then identify the selected path as valid or restricted.

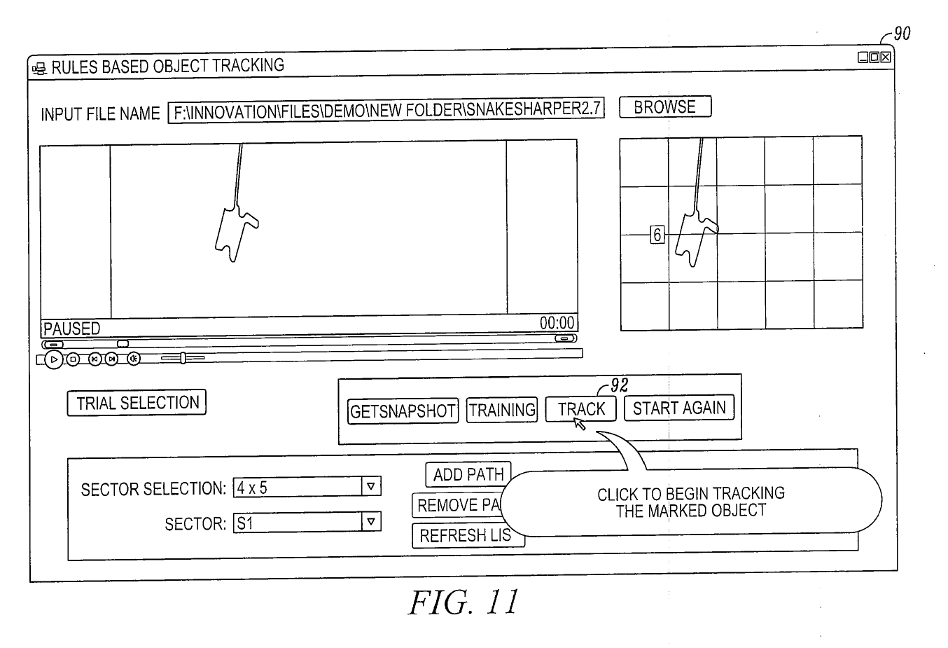

FIG. 11 is an interactive window 90 displayed on a viewing screen of a graphical user interface for tracking the path of a selected object in accordance with the present invention. Once valid or restricted paths are selected or configured, a user can select a TRACK button 92, for example, to begin tracking the selected object.

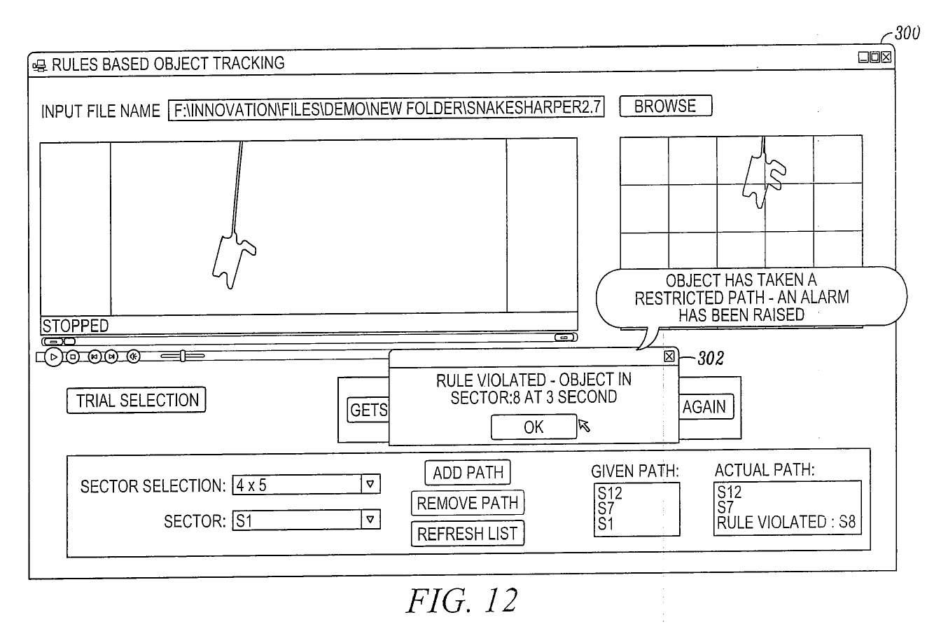

Once tracking begins, the selected video data stream can play, and the path of any selected objects in the video data stream can be tracked. FIG. 12 is an interactive window 300 for notifying a user that a selected object has traveled in a restricted path. When an object is selected, the selected object's path is tracked. If the selected object travels in a restricted path, an alarm can be provided to a user by, for example, a pop up window 302.

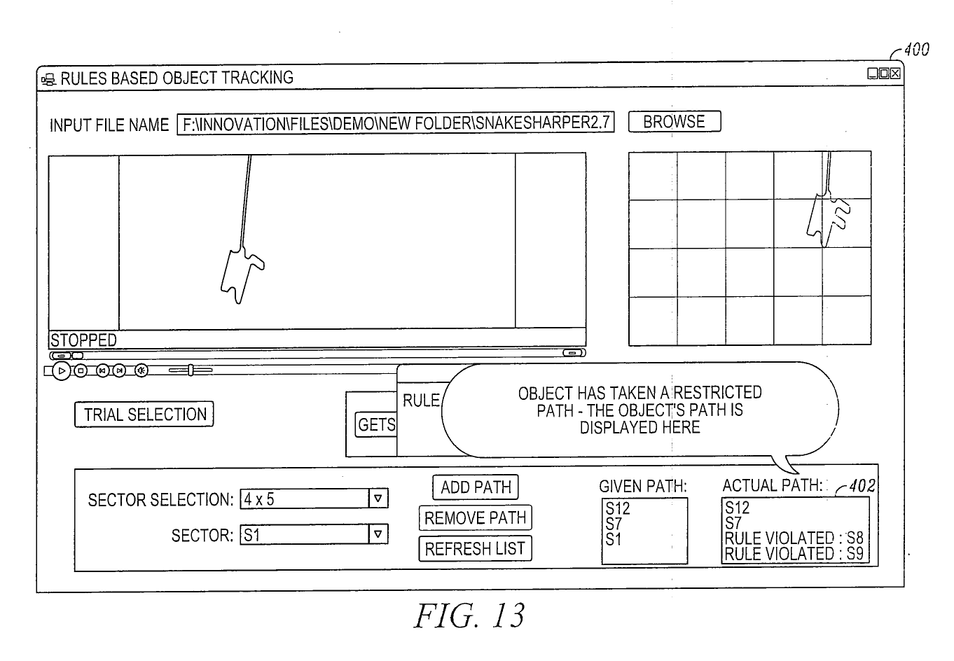

When the selected video data stream is completed, the actual path that any selected object traveled can be displayed to a user. FIG. 13 is an interactive window 400 for displaying the path of a selected object. For example, the actual path of the selected object can be displayed in a sub-window 402.

In embodiments of the present invention, the actual path traveled by a selected object can be displayed with reference to a grid and its associated rectangular areas. In further embodiments of the present invention, portions of the object's path that are in a restricted path can be identified in the display of the object's complete path.

In accordance with the present invention, the interactive and viewing windows shown and described can be used to configure an object to be tracked, and configure a path in which the object is permitted to or restricted from moving. The object can be user-configurable. If an object is found that is similar to the configured object, the similar object can also be tracked. If the configured object or other similar object deviates from a permitted path or enters a restricted path, then an alarm can be provided to the user.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the sprit and scope of the claims.

What is claimed is:

1. A method comprising:
displaying a video data stream of a monitored region;
configuring an object in the video data stream;
configuring a valid path of the object;
tracking a path of the object; and
providing an alert to a user when the object travels outside of the valid path.

2. The method of claim 1 wherein displaying the video data stream includes displaying a frame of the video data stream.

3. The method of claim 2 wherein displaying the frame of the video data stream includes associating a grid with the frame.

4. The method of claim 1 wherein configuring an object in the video data stream includes identifying properties of the object.

5. The method of claim 4 wherein identifying properties of the object includes identifying a perimeter of the object or identifying a color of the object.

6. The method of claim 4 further comprising:
identifying a second object with similar properties of the object; and
tracking a path of the second object.

7. The method of claim 1 wherein configuring a valid path of the object includes configuring a restricted path of the object.

8. The method of 1 wherein tracking a path of the object includes determining coordinates of the object on a grid associated with the video data stream.

9. The method of claim 1 wherein tracking a path of the object includes computing a trajectory of the object.

10. The method of claim 9 further comprising determining if the trajectory of the object consistent with the valid path of the object.

11. A system comprising:
circuitry that displays a video data stream of a monitored region;
circuitry that accepts user input to configure an object in the video data stream;
circuitry that accepts user input to configure a valid path of the object;
circuitry that tracks a path of the object; and
circuitry that provides an alert to a user when the object travels outside of the valid path.

12. The system of claim 11 wherein the circuitry that accepts user input to configure the object includes circuitry that accepts user input to identify the object.

13. The system of claim 12 further comprising:
circuitry that identifies properties of the object;
circuitry that identifies a second object with similar properties of the object; and
circuitry that tracks a path of the second object.

14. The system of claim 11 wherein the circuitry that accepts user input to configure a valid path of the object includes circuitry that accepts user input to configure a restricted path of the object.

15. The system claim 11 wherein the circuitry that tracks the path of the object includes circuitry that associates a grid with the video data stream, and circuitry that determines coordinates of the object with respect to the grid.

16. The system of claim 11 wherein the circuitry that tracks the path of the object includes circuitry that computes a trajectory of the object.

17. The system of claim 16 wherein the circuitry that computes the trajectory of the object includes circuitry that determines if the trajectory of the object is consistent with the valid path of the object.

18. An apparatus comprising:
a programmable processor and associated control circuitry; and
a user interface, wherein the user interface displays a video data stream of a monitored area, accepts user input to configure an object in the video data stream, accepts user input to configure a valid path of the object, and displays an alert when the object travels outside of the valid path.

19. The apparatus of claim 18 wherein the programmable processor and associated control circuitry track a path of the object.

20. The apparatus of claim 19 wherein the programmable processor and associated control circuitry determine if the object travels outside of the valid path.
